(19) United States
(12) Patent Application Publication
(10) Pub. No.: US 2005/0001420 A1
(43) Pub. Date: Jan. 6, 2005

(54) Photograph album with easel

(76) Inventor: Barry Dean Gordon, Sudbury, MA (US)

Correspondence Address: HARNESS, DICKEY, & PIERCE, P.L.C, 7700 BONHOMME, STE 400, ST. LOUIS, MO, 63105, US

(21) Appl. No.: 10/883,219

(22) Filed: Jul. 1, 2004

Related U.S. Application Data
(60) Provisional application No. 60/484,159, filed on Jul. 1, 2003.
(60) Provisional application No. 60/484,161, filed on Jul. 1, 2003.

(51) Int. Cl. B42D 3/00

(52) U.S. Cl. 281/33

(57) ABSTRACT

A photograph album includes a back cover that defines a recess. An easel is pivotably coupled to the back cover for pivotal movement between an open position and a closed position. When in the open position, the easel extends from the back cover such that the album can be supported by the easel on a generally horizontal surface. When in the closed position, however, the easel is within the recess and substantially flush with a back surface of the back cover thereby allowing the album to lay substantially flat on its back cover upon a generally horizontal surface.

### CROSS-REFERENCE TO RELATED APPLICATIONS

This application claims priority to U.S. Provisional Application No. 60/484,159, filed Jul. 1, 2003 and 60/484,161, filed Jul. 1, 2003, the entire disclosures of which are incorporated herein by reference.

### FIELD

The present invention relates to photograph albums, and more particularly to photograph albums with easels.

### BACKGROUND

People enjoy collecting, displaying, and viewing photographs of family, friends, pets, places, etc. To this end, a wide variety of photograph display devices can be used for storing, displaying, and viewing photographs in homes, offices and elsewhere.

### SUMMARY

A preferred embodiment includes a photograph album including a back cover that defines a recess. An easel is pivotably coupled to the back cover for pivotal movement between an open position and a closed position. When in the open position, the easel extends from the back cover such that the album can be supported by the easel on a generally horizontal surface. When in the closed position, however, the easel is within the recess and substantially flush with a back surface of the back cover thereby allowing the album to lay substantially flat on its back cover upon a generally horizontal surface.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a photograph album according to a preferred embodiment of the invention;

FIG. 2 is a side perspective view of the album shown in FIG. 1 and showing the easel in a deployed position;

FIG. 3 is a back perspective view of the album shown in FIG. 1;

FIG. 4 is a side perspective view of the album shown in FIG. 1 and showing the easel in a stowed position;

FIG. 5 is a bottom perspective view of the album shown in FIG. 1 and showing the flap in a closed position;

FIG. 6 is a bottom perspective view of the album shown in FIG. 1 and showing the flap in an open position;

FIG. 7 is a perspective view of the album shown in FIG. 1 and showing the album laying substantially flat on a generally horizontal surface;

FIG. 8 is a side perspective view of the album shown in FIG. 1 and showing the album supported by the easel on a generally horizontal surface;

FIG. 9 is a plan view of a photograph album according to a preferred embodiment of the invention;

FIG. 10 is a back elevation view of the album shown in FIG. 9;

FIG. 11 is a cross-sectional view of the back cover taken along the plane 11-11 in FIG. 10 and showing the easel in a stowed position;

FIG. 12 is a cross-sectional view of the front cover taken along the plane 12-12 in FIG. 9 and showing a photograph coupled to the front cover;

FIG. 13 is a top view of the album shown in FIG. 9 and showing the easel in a deployed position;

FIG. 14 is a back perspective view of a photograph album according to a preferred embodiment of the invention;

FIG. 15 is another back perspective view of the album shown in FIG. 14 but with the easel removed from the album;

FIG. 16 is another back perspective view of the album shown in FIG. 14 but with the easel in a stowed position; and

FIG. 17 is a cross-sectional side view of a spine hingedly connecting front and back covers of a photograph album according to a preferred embodiment of the invention.

Corresponding reference numerals indicate corresponding parts throughout the several views of the drawings.

### DETAILED DESCRIPTION OF THE EXEMPLARY EMBODIMENTS

The following description of the exemplary embodiments is merely exemplary in nature and is in no way intended to limit the invention, its application, or uses.

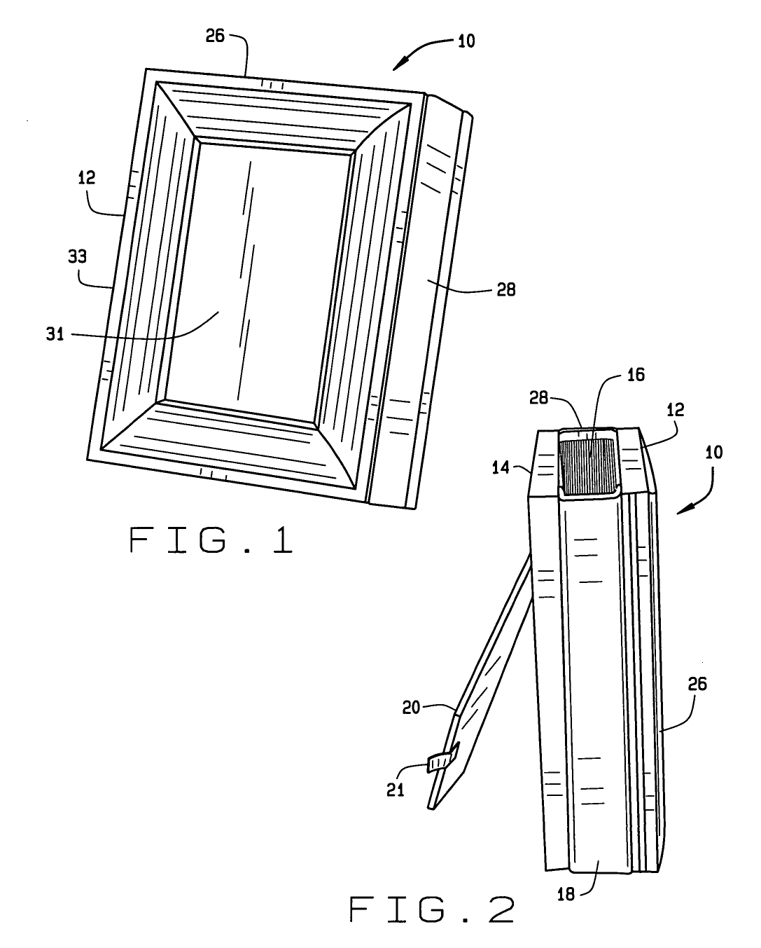

FIGS. 1 through 8 illustrate an exemplary photograph album 10 in accordance with the principles of this invention. As shown, the album 10 includes a front cover 12, a back cover 14, and one or more pages 16 held between the covers 12 and 14. The album 10 can be adapted such that pages 16 can be removed from or added to the album 10.

Each page 16 can include one or more photomounts for receiving and supporting at least one photograph. Such photomounts can include various means for supporting photographs on the pages 16 within the album 10 including inserts, holders, leafs, sleeves, adhesives, etc.

Further, photomounts can be provided on the front and/or back side of the pages 16. Photomounts can also be configured to support photographs in either or both a landscape orientation and/or a portrait orientation relative to the pages 16. It should be further noted that each album page need not include the same number of photomounts, the same shape of photomounts, the same size photomounts (e.g., photomounts sized to receive photograph sizes of 3.5″×3.5″, 3″×5″, 4″×6″, 8″×10″, etc.) and/or photomounts arranged or orientated in the same manner.

In the illustrated embodiment, the front and back covers 12, 14 and pages 16 are generally rectangular. Alternatively, other suitable shapes can be employed for the covers 12, 14 and pages 16, such as circular or square. The covers 12, 14 and pages 16 can also be provided in various sizes depending at least in part on the size of the photographs to be displayed by the album 10.

The covers 12, 14 and pages 16 can also be decorated with a wide range of indicia including advertising content, trademarks, trade names, service marks, graphic images, graphic elements, designs, artwork, distinctive marks, identifying symbols, company logos, company contact information, text, alphanumeric characters, sports team insignias, names, monograms, photographs, among others. For example, the border or frame 26 can include textual messages, ornate decorations, etc.

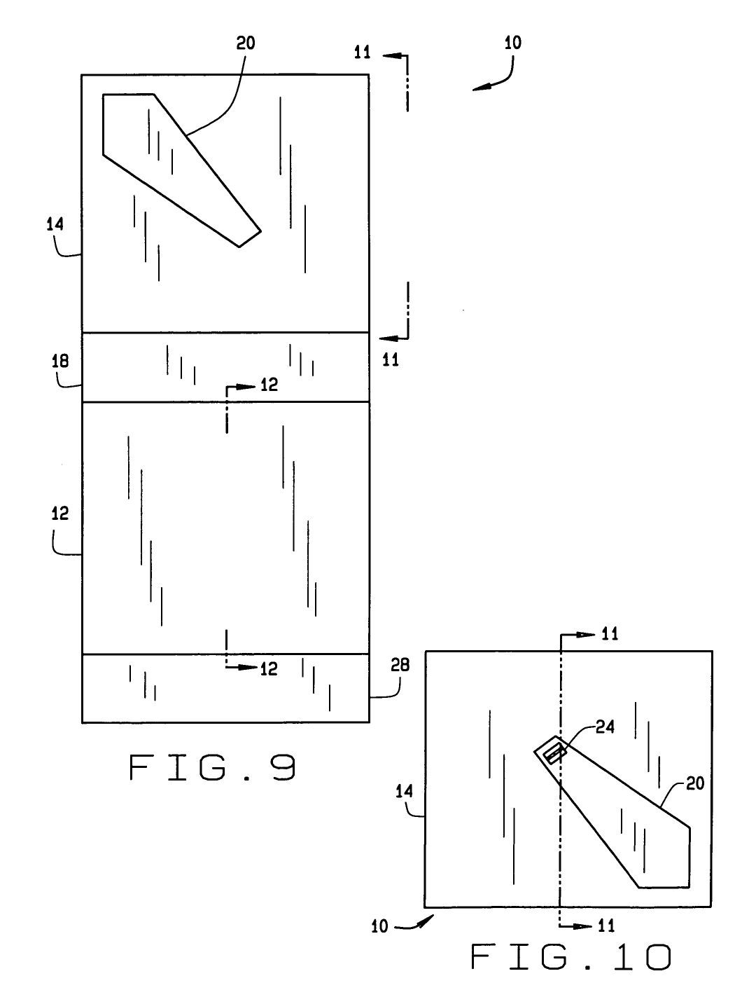

A hinge 18 can be used to hingedly connect the front and back covers 12 and 14 to one another, thereby enabling the album 10 to be opened and closed. As shown in FIGS. 2 and 9, the spine 18 is orientated such that the spine 18 connects the front and back covers 12 and 14 along the left side of the album 10 such that the album 10 can be opened horizontally by a user. Alternatively, the spine 18 can instead be positioned along the top portion of the covers 12 and 14. In which case, the album 10 may be opened to view photographs within the holders 16 by lifting the front cover 12 up and away from the viewer (i.e., the photograph album 10 opens vertically).

The covers 12 and 14, pages 16, and spine 18 can be formed from a wide range of materials. Preferably, the back cover 14 is made of a relatively soft material to prevent, or at least reduce, the possibility of the album 10 scratching the surface on which it is placed. For instance, a preferred embodiment includes a back cover 14 formed from one or more materials softer (e.g., flocked felt, etc.) than unfinished pine as unfinished pine is a relatively soft and commonly used wood. Because the album 10 will likely be placed with its back cover 14 (and not front cover 12) in contact with the a generally horizontal surface, the front cover 12 can be made from a wide variety of aesthetically pleasing materials (e.g., a ceramic, metal, etc.) without fear of damaging or scratching the surface on which it is placed.

In addition, it is also generally preferred to form the back cover 14 from one or more materials so as to provide the back cover 14 with a relatively high coefficient of friction. This, in turn, would help the album 10 resist sliding relative to the surface supporting the album 10.

With further reference to FIG. 2 through 4, an easel 20 is pivotably coupled to the back cover 14 for pivotal movement between an open or deployed position (FIG. 2) and a closed or stowed position (FIG. 4). When deployed, the easel 20 can be used to support the album 10 generally upright on a generally horizontal surface 29 (e.g., a tabletop, coffee tabletop, desktop, shelf, etc.) as shown in FIG. 8.

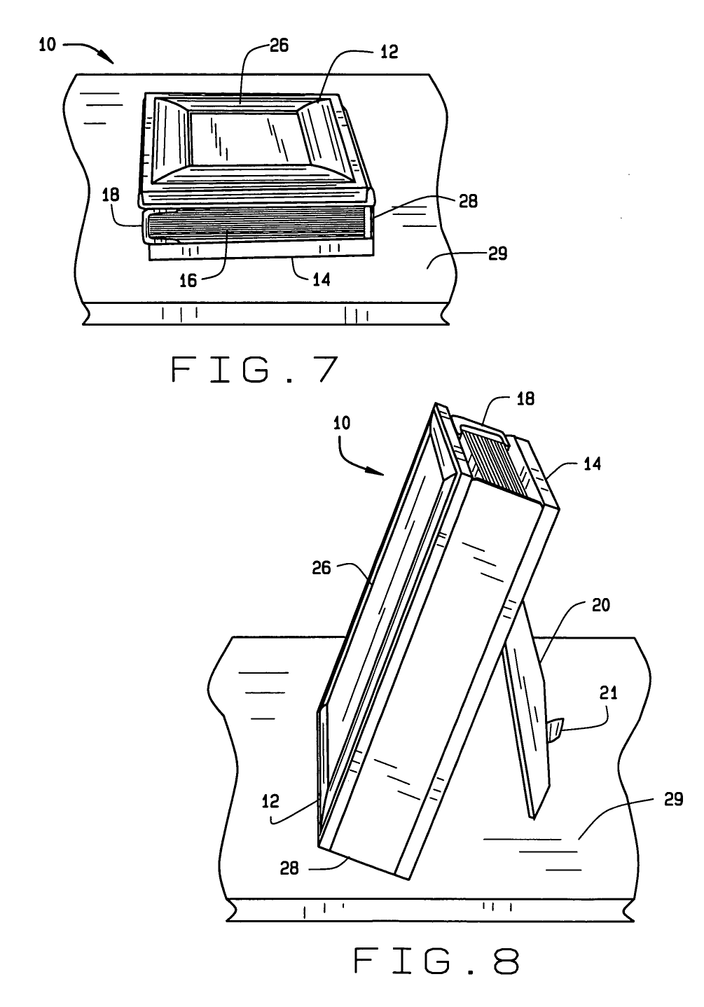

But when stowed, however, the easel 20 is received within a recess 22 defined in the back cover 14. Indeed, the easel 20 and recess 22 are preferably sized (e.g., depth, etc.) and shaped accordingly so that the easel 20 lies substantially, and preferably completely, within the recess 22 when the easel 20 is in the stowed position. In which case, the easel 20 in the stowed position is at least substantially flush with a back surface 15 and does not extend outwardly beyond the back surface 15, thereby allowing the album 10 to lay substantially flat when the back surface 15 is on the generally horizontal surface 29, as shown in FIG. 7. In other embodiments, the easel and recess can be configured such that the easel when in the stowed position is entirely within the recess such that a spaced distance is defined between or separates the back surface of the easel and the back surface of the back cover.

Additionally, the length of the easel 20 preferably allows the album 10 to lean upon and be supported by the easel 20 at an aesthetically pleasing, oblique angle so that a photograph coupled to the front cover 12 is oriented in a generally diagonally upwardly direction.

A wide range of materials can be used for the easel 20 including plastics, cardboard, wood, metal, etc.). In a preferred embodiment, the easel 20 is formed from one or more materials so as to provide the easel 20 with a relatively high coefficient of friction. This, in turn, would help the album 10 resist sliding relative to the surface on which the album 10 is being supporting by the easel 20.

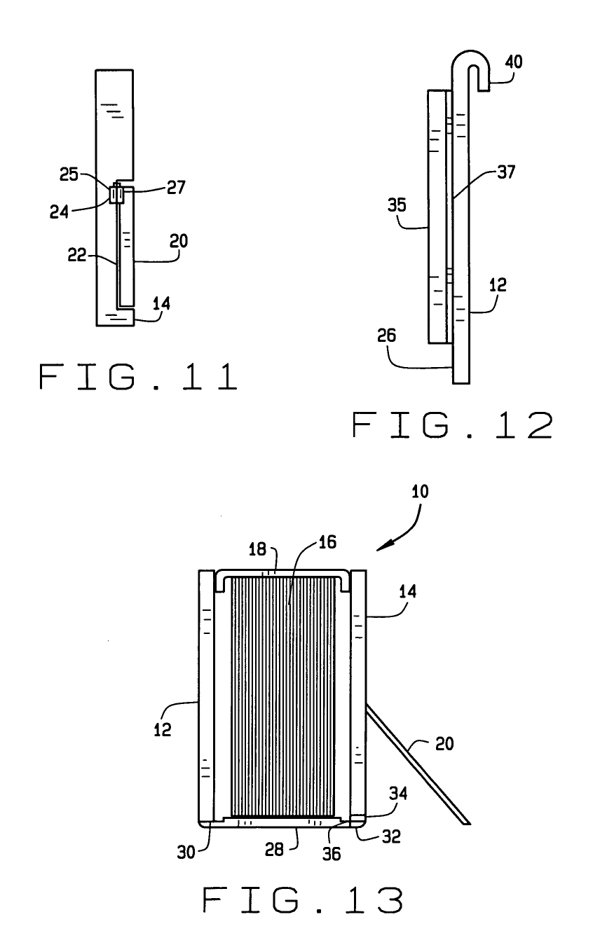

Further, various means can be employed for pivotably coupling the easel 20 to the back cover 14. For example, FIG. 11 illustrates a hinge 24 having generally opposed sides 25 and 27. The hinge side 25 is attached to the back cover 14 near a top end portion of the recess 22, while the other hinge side 27 is attached to the easel 20. The hinge 24 is preferably recessed into the back cover 14 and easel 20. In this exemplary manner, the hinge 24 pivotably couples the easel 20 to the back cover 14 and allows the easel 20 to be pivotably moved between the stowed position (FIG. 11) and the deployed position (FIG. 13).

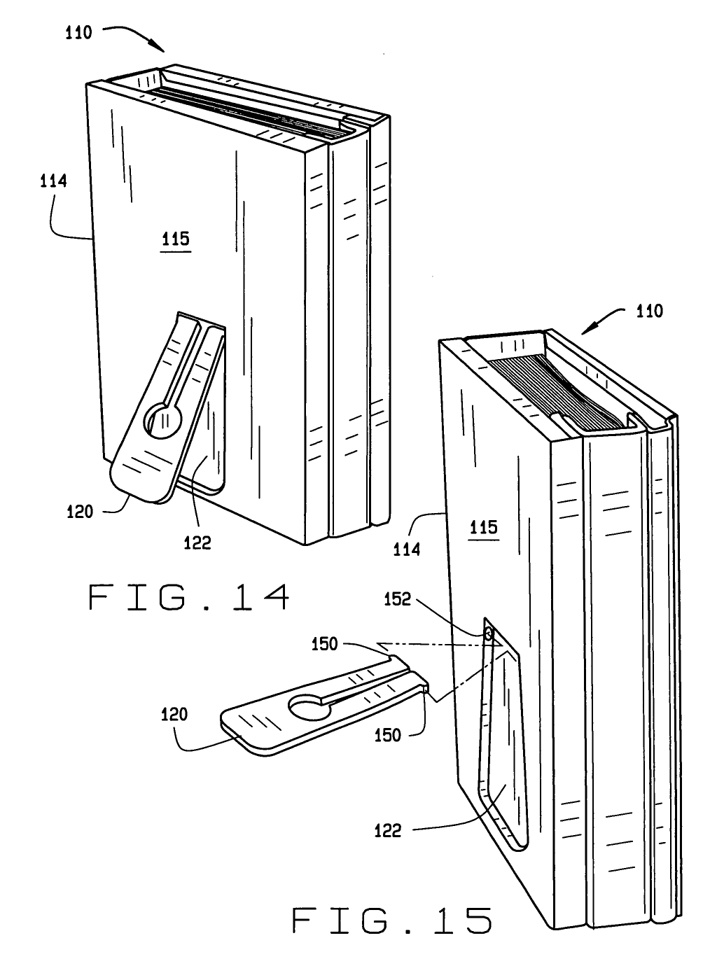

In various implementations, the easel can also be removable from the album. For example, FIGS. 14 through 16 illustrate a photograph album 110 including an easel 120 removably coupled to the back cover 114. As shown in FIG. 15, the easel 120 includes resiliently outwardly biased protuberances 150. Each protuberance 150 is sized to be received and retained within a corresponding opening or recess 152 defined by the back cover 114. To remove the easel 120, a user squeezes the easel 120 with sufficient force to overcome the generally outward bias of the protuberances 150. At that point, the protuberances 150 disengage from the openings 152 and the easel 120 can be detached from the back cover 114. To reattach the easel 120 to the back cover 114, the user again sufficiently squeezes the easel 120 to allow the protuberances 150 to be inserted into the openings 152.

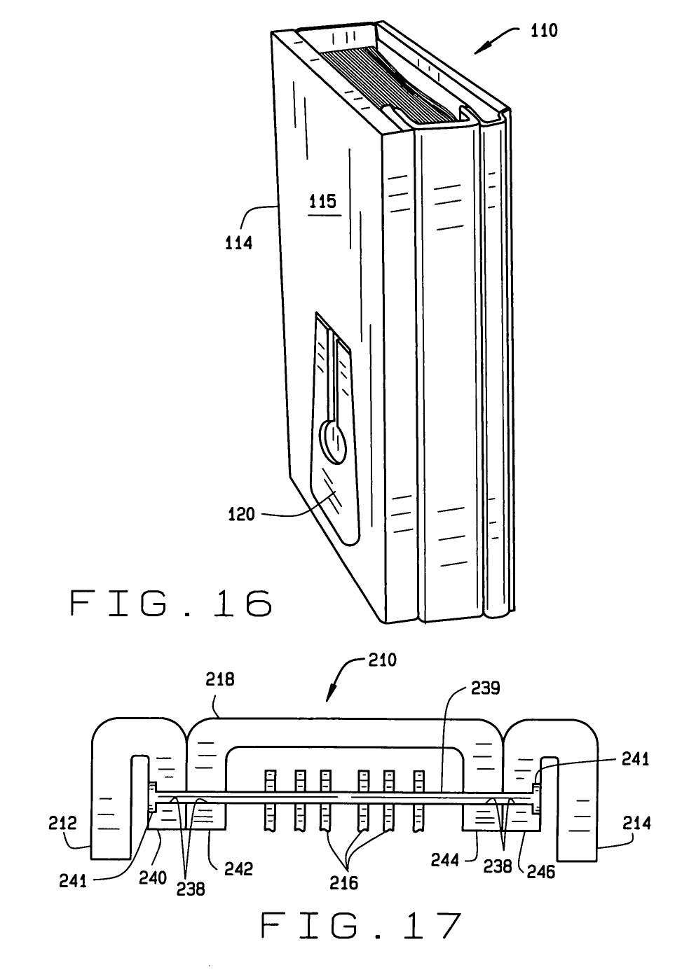

With further reference to FIG. 16, the easel 120 and recess 122 are sized and shaped accordingly so that the easel 120, when pivotably moved into the stowed position, is within the recess 122 and at least substantially flush with the back surface 115. This allows the album 110 to lay substantially flat while the back surface 115 is on a generally horizontal surface.

Various embodiments of a photograph album can also include an easel and back cover that are monolithically formed as a single component. In such embodiments, the easel would not be separately attached to the back cover. By way of example, an exemplary embodiment includes an easel and back cover that are integrally formed from a plastic material with a hinge line or living hinge defined therebetween. The living hinge allows the easel to be pivotably moved between a deployed position and a stowed position in which the easel is within a recess defined by a back cover of the album.

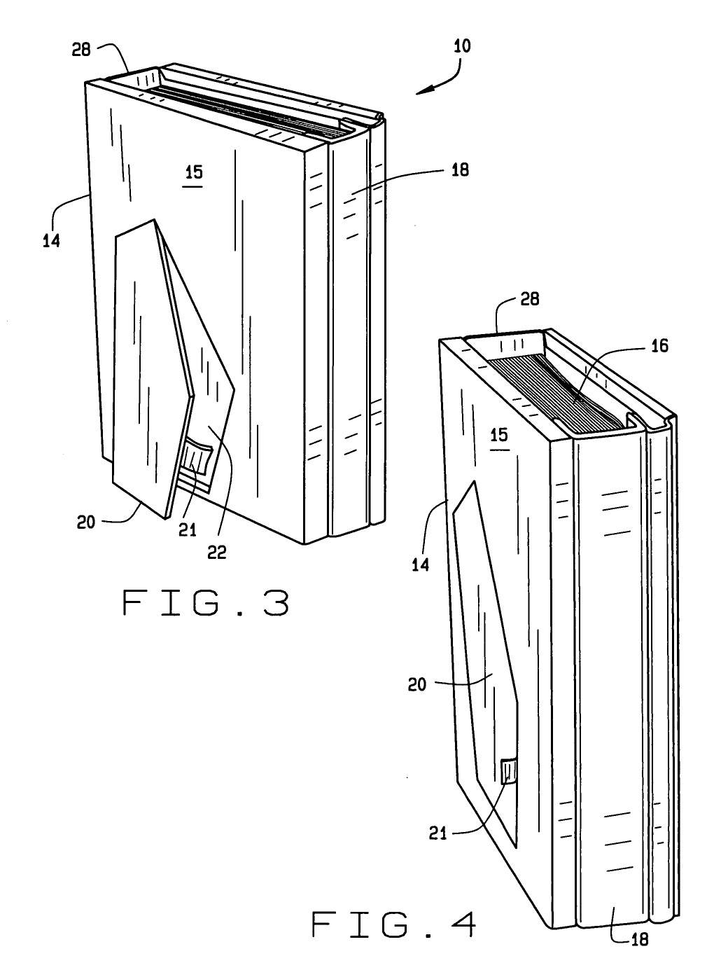

Referring now to FIGS. 3 and 4, a pull tab 21 can be attached to the easel 20 to assist with deployment of the easel 20. When the easel 20 is in the stowed position, the tab 21 can be pulled generally outwardly from the back cover 14 to pivotably move the easel 20 to the deployed position.

To help ensure that the easel 20 does not unintentionally deploy, the easel 20 can be releasably engageable to the back cover 14. This releasable engagement can be accomplished by using any of a wide range of suitable fastening means (e.g., Velcro® hook and loop closures, magnets, friction fit, etc.). By way of example, the easel 20 and recess 22 can be appropriately sized and shaped so that an interference fit is created between the easel 20, when stowed, and the side surfaces defining the recess 22. This interference fit can removably and frictionally retain the easel 20 in its stowed position within the recess 22.

The album 10 can also include at least one photomount coupled to a front surface 26 of the front cover 12 for temporarily or permanently supporting one or more photographs, pictures, documents, other graphic images, etc. As shown in FIG. 1, the front cover 12 preferably includes a generally transparent window 31 through which a photograph can be viewed. A wide range of materials can be used for the window 31 including glass, acrylic material, plastics, etc.

The window 31 is generally surrounded by a frame or border 33. The frame 33 can be a separate component that is attached to the front cover 12 via suitable fastening means (e.g., adhesives, finishing screws, Velcro® hook and loop closures, magnets, etc.). Alternatively, the frame 33 and front cover 12 can be monolithically formed as a single component. Various materials can be used for the frame or border 33 including plastics, metals, woods, etc.

In the illustrated embodiment shown in FIG. 1, the window 31 and frame 33 are both generally rectangular. Alternatively, other suitable shapes (e.g., circular, square, triangular, etc.) can be employed for the window 31 and/or frame 33. Further, the window 31 and frame 33 can also be provided in various sizes depending at least in part on the size (e.g., 3.5″×3.5″, 3″×5″, 4″×6″, 8″×10″, 8½″×11″, etc.) of the photograph(s) or other item(s) (e.g., degree, certificate, document, etc.) to be supported and displayed thereby.

Alternatively, various other means can be employed for the photomount(s) coupled to the front surface 26 of the front cover 12. For example, and as shown in FIG. 12, a photograph 35 or other indicia (e.g., graphic images, document, artwork, etc.) can be temporarily or permanently coupled to the front surface 26 with an adhesive 37. Or for example, a photograph may be inserted into a pocket or cavity defined on the front surface 26 of the front cover 12.

In yet other embodiments, the album may include one or more pedestals each mounting a corresponding photomount to the front surface of the front album cover. Such pedestals can be variously sized. Further, each pedestal may have a different height such that the photomounts are spaced at different distances away from the front surface of front album cover. In which case, each photomount is mounted via its corresponding pedestal in a different plane than the other photomounts coupled to the front cover. Moreover, the photomounts mounted by the pedestals may be arranged such that at least one photomount has a landscape orientation while at least one other photomount has a portrait orientation. A wide range of materials can be used for the pedestals, such as generally lightweight plastic or acrylic materials.

When at least one photograph is supported by at least one photomount coupled to the front surface 26, the album 10 can be supported by the deployed easel 20 upon a generally horizontal surface (e.g., coffee table, desktop, etc.) as shown in FIG. 8. Accordingly, the album 10 can thus serve as a display device for the at least photograph supported by the photomount coupled to the front surface 26.

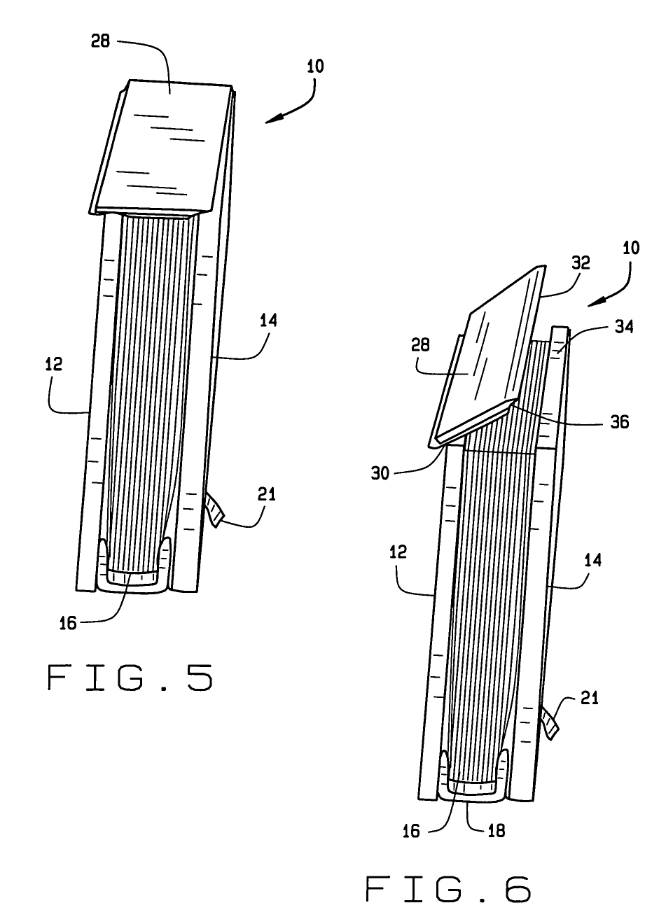

Turning now to FIGS. 5, 6, and 13, the album 10 can also include a flap 28 hingedly coupled to one of the front and back cover 12, 14, while being releasably engageable to the other cover 12 or 14. As shown in FIGS. 5, 6 and 13, the flap 28 is hingedly connected to the front cover 12 by a spine 30. The flap 28 is also releasably engageable to the back cover 14 such that the flap 28 can be used to hold the album 10.

When engaged with both the front and back covers 12 and 14, the flap 28 can also at least partially support the weight of the front cover 12 while the album 10 is laying substantially flat with its back cover 14 upon a generally horizontal surface. In this exemplary manner, the flap 28 can thus help maintain the separation between the covers 12 and 14 to prevent, or at least reduce, the covers 12 and 14 from compressing upon and damaging the photographs coupled to the pages 16. The flap 28 can also square off the album 10 and provide the album 10 with a more pleasant aesthetic quality.

The releasable engagement of the flap 28 to the corresponding front or back cover 12 or 14, as the case may be, can be accomplished with various fastening means (e.g., snaps, buttons, clasps, Velcro® hook and loop closures, magnets, buckles, etc.). By way of example only, the flap 28 can be magnetically attachable to the corresponding front or back cover 12 or 14.

As shown in FIG. 13, magnetically attachable members 32 and 34 can be respectively coupled to (e.g., embedded in, etc.) the flap 28 and back cover 14, or vice versa. One of the members 32 or 34 can formed from a permanent magnetic material (e.g., neodymium-iron-boron (Nd-Fe-B), etc.) while the other member 32 or 34 can be formed of a magnetically permeable materials (e.g., iron, steel, etc.). In this exemplary manner, the members 32 and 34 can be magnetically attached to one another to thereby releasably engage the flap 28 to the back cover 14.

Additionally, the flap 28 may include a lip 36 so that the photograph album 10 may rest substantially flat on the flap 28. The lip 36 can also facilitate the releasable engagement of the flap 28 to the back cover 14. Alternatively, the album 10 can include a flap along any one or more (or all) of the sides of the album 10. In embodiments in which all sides of the album include either a spine or flap, the album can thus protect the photographs therein from each side of the album.

FIG. 17 illustrates an exemplary embodiment by which a spine 218 can be used to hingedly connect the front and back covers 212, 214 of a photograph album 210 in accordance with the principles of this invention. The spine 218 can be disposed along any side portion (e.g., left, right, top, bottom, etc.) of the album 210. As shown, one or more connectors 239 can be used to coupled the pages 216 to the album 210. The connector 239 can also help to hold the front cover 212, the back cover 214, and the spine 218 together.

In a preferred embodiment, the connector 239 passes through a series of generally aligned holes 238 defined by a fold 240 of the front cover 212, folds 242 and 244 of the spine 218, and a fold 246 of the back cover 214. The heads 241 of the connector 239 are preferably countersunk or recessed into the front cover fold 240 and back cover fold 246. This countersinking allows the main body portions of the covers 212 and 214 to contact or rest against the folds 240 and 246 in a relatively compact and attractive configuration. In alternative embodiments, the heads 241 of the connector 239 may instead protrude slightly beyond folds 240 and 246 to impart more depth to the assembled photograph album 210.

In various other embodiments, the album can also include a support device that can be used to support the album from a generally vertical support surface, such as a wall. In such embodiments, the album can include a hanger coupled to the back cover. Alternatively, hangers can also be placed elsewhere depending at least in part on the orientation of the photograph(s) to be displayed by the one or more photomounts coupled to the front surface of the album.

In yet other embodiments, an album can be provided with other suitable support devices such as magnets. For example, an album can include a permanent magnet (e.g., embedded within the back cover, etc.) of sufficient strength to allow the album to be magnetically attached to a magnetically permeable surface (e.g., refrigerator door, etc.) without any further support devices or methods being needed.

In another form, the present invention provides methods of displaying photographs. In one implementation, a method generally includes coupling at least one photograph to a front surface of a photo album, pivotably moving an easel to stow the easel entirely within a recess defined by a back cover of the photo album, and positioning the album substantially flat with the back cover upon a generally horizontal surface. The method can also include pivotably moving the easel from within the recess to deploy the easel, and supporting the album with the deployed easel on the generally horizontal surface. One or more photographs can also be coupled to at least one page of the album.

In yet another form, the present invention provides methods of converting a photo album from laying substantially flat on a generally horizontal surface to being supporting at an oblique angle on the generally horizontal surface. In one implementation, a method generally includes pivotably moving an easel from within a recess defined by a back cover of the album to deploy the easel, and supporting the album with the deployed easel at the oblique angle on the generally horizontal surface.

In still another form, the present invention provides methods of converting a photo album from being supported at an oblique angle on a generally horizontal surface to laying substantially flat on the generally horizontal surface. In one implementation, a method generally includes pivotably moving an easel to stow the easel entirely within a recess defined by a back cover of the album, and positioning the album substantially flat with the back cover upon the generally horizontal surface.

The description of the invention is merely exemplary in nature and, thus, variations that do not depart from the gist of the invention are intended to be within the scope of the invention. Such variations are not to be regarded as a departure from the spirit and scope of the invention.

1. A photograph album comprising a back cover defining a recess, and an easel pivotably coupled to the back cover for pivotal movement between an open position in which the easel extends generally outwardly from the back cover and a closed position in which the easel is within the recess and at least substantially flush with a back surface of the back cover.

2. The album of claim 1, further comprising a front cover hingedly coupled to the back cover and including a front surface.

3. The album of claim 2, further comprising at least one photomount coupled to a front surface of the front cover.

4. The album of claim 3, further comprising at least one frame coupled to the front surface of the front cover to generally surround a photograph supported by the at least one photomount.

5. The album of claim 2, further comprising a flap pivotably coupled to one of the front and back covers, and releasably engageable to the other of said front and back covers.

6. The album of claim 5, wherein the flap is magnetically attachable to the other of said front and back covers.

7. The album of claim 5, wherein the flap at least partially supports the weight of the front cover when the flap is engaged with the front and back covers and the album is laying substantially flat with the back cover upon a generally horizontal surface.

8. The album of claim 2, further comprising at least one photograph coupled to a front surface of the front cover.

9. The album of claim 1, further comprising at least one page for holding at least one photograph.

10. The album of claim 1, wherein the easel is removable from the back cover.

11. The album of claim 10, wherein:
the easel includes resiliently biased protuberances; and
the back cover defines openings each sized to receive and retain therein a corresponding one of the protuberance to removably couple the easel to the back cover.

12. The album of claim 1, wherein the back cover and the easel are monolithically formed as a single component.

13. The album of claim 1, wherein the easel and recess are sized so as to create an interference fit between the easel and side surfaces defining the recess in the back cover, the interference fit frictionally retaining the easel in the closed position within the recess.

14. The album of claim 1, wherein the easel and recess are sized such that the easel when in the stowed position is entirely within the recess and a spaced distance is defined between a back surface of the easel and the back surface of the back cover.

15. The album of claim 1, wherein the shape of the easel substantially conforms to the shape of the recess.

16. A combined photo album and frame comprising:
a first cover including a first surface and at least one photomount coupled to the front surface, thereby forming the frame;
a second cover hingedly coupled to the first cover and defining a recess;
at least one page, between the first and second covers, for holding at least one photograph; and
a support pivotably coupled to the second cover for pivotal movement between a deployed position in which the support extends from the second cover for supporting the album at an oblique angle on a generally horizontal surface, and a stowed position in which the support is within the recess and at least substantially flush with a back surface of the second cover thereby enabling the album to lay substantially flat with the back surface of the second cover upon a generally horizontal surface.

17. The combined photo album and frame of claim 16, further comprising at least one photograph supported by the at least one photomount.

18. The combined photo album and frame of claim 16, wherein the support and recess are sized such that the support when in the stowed position is entirely within the recess and a spaced distance is defined between a back surface of the support and the back surface of the back cover.

19. The combined photo album and frame of claim 16, wherein the shape of the support substantially conforms to the shape of the recess.

20. A photo album comprising:
a front cover including means for holding at least one photograph;
a back cover including means for defining a recess;
at least one page between the front and back cover, the page including means for holding at least one photograph;
means for supporting the photo album at an oblique angle on a generally horizontal surface;
means for pivotably coupling the means for supporting to the back cover for pivotal movement between a deployed position in which the means for supporting supports the album at an oblique angle on a generally horizontal surface, and a stowed position in which the means for supporting is within the recess and at least substantially flush with a back surface of the back cover.

21. The album of claim 20, further comprising means for holding the album closed and maintaining separation of the front cover from the back cover.

22. A method for displaying photographs, the method comprising coupling at least one photograph to a front surface of a photo album, pivotably moving an easel to stow the easel entirely within a recess defined by a back cover of the album, and positioning the album substantially flat with the back cover upon a generally horizontal surface.

23. The method of claim 22, further comprising pivotably moving the easel from within the recess to deploy the easel, and supporting the album with the deployed easel at an oblique angle on the generally horizontal surface.

24. The method of claim 22, further comprising coupling at least one photograph to at least one page of the album.

25. A method of converting a photo album from laying substantially flat on a generally horizontal surface to being supporting at an oblique angle on the generally horizontal surface, the method comprising pivotably moving an easel from within a recess defined by a back cover of the album to deploy the easel, and supporting the album with the deployed easel at the oblique angle on the generally horizontal surface.

26. A method of converting a photo album from being supported at an oblique angle on a generally horizontal surface to laying substantially flat on the generally horizontal surface, the method comprising pivotably moving an easel to stow the easel entirely within a recess defined by a back cover of the album, and positioning the album substantially flat with the back cover upon the generally horizontal surface.
